(19) United States
(12) Patent Application Publication
(10) Pub. No.: US 2026/0352340 A1
(43) Pub. Date: Nov. 5, 2026

(54) INCREASED DATA RATE USING a Pi-MODULATOR

(71) Applicant: Axalume, Inc., Cayenne Creek Rd., CA (US)

(72) Inventors: Ashok V. Krishnamoorthy, San Diego, CA (US); Yossef Ehrlichman, San Diego, CA (US)

(73) Assignee: Axalume, Inc., San Diego, CA (US)

(21) Appl. No.: 19/196,734

(22) Filed: May 1, 2025

(51) Int. Cl. H04B 10/548; G02F 1/21; H04B 10/54

(52) U.S. Cl. CPC H04B 10/548; G02F 1/212; H04B 10/54

(57) ABSTRACT

A π-modulator encoder in an π-modulator may provide, based on an input data stream having a bit time, at least a first encoded data stream and a second encoded data stream, which each have the bit time. Moreover, a phase delay element in the π-modulator may apply a predefined temporal delay to the second encoded data stream, so that the first encoded data stream and the second encoded data stream are temporally offset from each other. Next, a segmented optical modulator, which includes at least a first phase modulator and a second phase modulator in series with each other, may provide an output optical data stream having one half of the bit time. Notably, the first phase modulator may modulate an optical signal based on the first encoded data stream and the second phase modulator may modulate the optical signal based on the second encoded data stream.

### BACKGROUND

### Field

The present disclosure relates to techniques for increasing a data rate by aggregating data. More specifically, the present disclosure relates to aggregating data using a π-modulator.

### Related Art

Data centers are increasing applications of high-speed interconnects beyond 100 Gb/s per lane. Achieving such high data rates typically requires the use of optical interconnects. A major bottleneck to achieving optical interconnects with such high-data rates is the photonic or electro-optical modulator (EOM).

Two approaches for overcoming this bottleneck is to design a faster EOM or by employing advanced modulation formats, such as pulse-amplitude modulation 4 (PAM-4). For example, an existing 50 GHz micro-ring modulator with PAM-4 has achieved 128 Gb/s. Furthermore, a silicon photonic dual-drive Michelson interferometric modulator with PAM-4 has achieved 56 Gb/s. However, it is typically very difficult to increase the speed of EOM without using exotic materials. Additionally, when higher modulation formats (such as PAM-8) or coherent modulation formats (such as 16 quadrature amplitude modulation or 16-QAM) are used, the burden on the receiver is increased.

Another technique for increasing the aggregate data rate of an optical link or interconnect is optical time-division multiplexing. Notably, this technique can improve the aggregate data rate by multiplexing a number of low bit-rate optical channels in the time domain. Typically, the channel allocation in time-division multiplexing is dependent on the fundamental electrical data rate and the optical pulse width. When the electrical clock is fixed, the optical pulse width is often decreased in order to multiplex more channels within the clock period. However, short optical pulses are often subject to a heavy dispersion penalty as the communication distance increases.

### SUMMARY

One embodiment of the present disclosure provides a π-modulator. This π-modulator may include an input node that receives an input data stream having a bit time. Moreover, the π-modulator may include a π-modulator encoder that provides, based on the input data stream, at least a first encoded data stream and a second encoded data stream, which each have the bit time. Moreover, the π-modulator may include a phase delay element that applies a predefined temporal delay to the second encoded data stream, where, following the phase delay element, the first encoded data stream and the second encoded data stream may be temporally offset from each other. Furthermore, the π-modulator may include a segmented optical modulator with at least a first phase modulator that modulates an optical signal based on the first encoded data stream and a second phase modulator that modulates the optical signal based on the second encoded data stream, where the first phase modulator and the second phase modulator are in series. Additionally, the segmented optical modulator may provide an output optical data stream having one half of the bit time.

Note that the π-modulator encoder may encode at least the first encoded data stream and the second encoded data stream to include expediting symbols that expedite signal transitions in the output optical data stream at a data rate corresponding to one half of the bit time. Moreover, the π-modulator encoder may phase encode at least the first encoded data stream and the second encoded data stream. Consequently, the expediting symbols may include phases of 0° and 180°, and the output optical data stream may have phases of 0°, 180° and 360°. In some embodiments, the output optical data stream may have a first amplitude for a phase of 0° or 360° and a second amplitude for a phase of 180°. For example, a subsequent symbol in the second encoded data stream may be an exclusive or of a current symbol in the first encoded data stream with a subsequent symbol in the input data stream. Alternatively, a subsequent symbol in the first encoded data stream may be an exclusive or of a current symbol in the second encoded data stream with a subsequent symbol in the input data stream.

Furthermore, the temporal delay may be one half of the bit time.

Additionally, the π-modulator may include at least a first amplifier and a second amplifier between the π-modulator encoder and the segmented optical modulator, where the first amplifier amplifies the first encoded data stream and the second amplifier amplifies the second encoded data stream.

In some embodiments, a given phase modulator includes a Mach-Zehnder interferometer that is driven with a same signal in both arms, and each of the arms includes an electro-optical modulator. For example, the electro-optical modulator may include one of: a micro-ring modulator, a micro-disk modulator, an electro-absorption modulator or a direct digital-drive modulator.

Moreover, the π-modulator may include an optical source that provides the optical signal.

Furthermore, the segmented optical modulator may include a first electrode corresponding to the first phase modulator in a first region of the segmented optical modulator and a second electrode corresponding to the second phase modulator in a second region of the segmented optical modulator. In some embodiments, the segmented optical modulator may include one of: a Mach-Zehnder interferometer, a micro-ring modulator, a micro-disk modulator, an electro-absorption modulator, a direct digital-drive modulator, or another electro-optical modulator.

Additionally, the first electrode and the second electrode may have different lengths, and the first encoded data stream and the second encoded data stream may include three amplitude levels. Alternatively, the first electrode and the second electrode may have the same length, and the first encoded data stream and the second encoded data stream may include five or six amplitude levels.

Moreover, the π-modulator may implement at least PAM-4. In these embodiments, the first electrode may include two electrodes for a least-significant byte (LSB) in the first encoded data stream and a most-significant byte (MSB) in the first encoded data stream. Furthermore, the second electrode may include two electrodes for an LSB in the second encoded data stream and an MSB in the second encoded data stream.

Note that, at a given time during operation, one of the first phase modulator and the second phase modulator may be modulating the optical signal.

In some embodiments, the π-modulator implements one of: N phase-shift keying (N-PSK), PAM-N, quadrature phase-shift keying (QPSK), or N-QAM, where N is a non-zero integer.

Another embodiment provides a method for providing an output optical data stream, which may be performed by a π-modulator.

Another embodiment provides a device that includes a π-modulator.

Another embodiment provides a system that includes a π-modulator.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a drawing illustrating an example of the operation of a π-modulator in accordance with an embodiment of the present disclosure.

FIG. 2 is a block diagram illustrating an example of a π-modulator in accordance with an embodiment of the present disclosure.

FIG. 3 is a block diagram illustrating an example of a π-modulator with Mach-Zehnder interferometers in accordance with an embodiment of the present disclosure.

FIG. 4 is a block diagram illustrating an example of a π-modulator with electro-absorption modulators in accordance with an embodiment of the present disclosure.

FIG. 5 is a block diagram illustrating an example of a π-modulator with two electro-optical modulators in series in accordance with an embodiment of the present disclosure.

FIG. 6 is a block diagram illustrating an example of a pulse-amplitude modulator N (PAM-N) π-modulator in accordance with an embodiment of the present disclosure.

FIG. 7 is a block diagram illustrating an example of a π-modulator with a segmented optical modulator in accordance with an embodiment of the present disclosure.

FIG. 8 is a block diagram illustrating an example of a PAM-4 π-modulator with a segmented optical modulator in accordance with an embodiment of the present disclosure.

FIG. 9 is a drawing illustrating an example of a constellation diagram for binary phase-shift keying (BPSK) in accordance with an embodiment of the present disclosure.

FIG. 10 is a drawing illustrating an example of a constellation diagram for quadrature phase-shift keying (QPSK) in accordance with an embodiment of the present disclosure.

FIG. 11 is a block diagram illustrating an example of 16 quadrature amplitude modulator (16-QAM) π-modulator in accordance with an embodiment of the present disclosure.

FIG. 12 is a drawing illustrating an example of a constellation diagram for 16-QAM in accordance with an embodiment of the present disclosure.

FIG. 13 is a flow chart illustrating a method for providing an output optical data stream in accordance with an embodiment of the present disclosure.

FIG. 14 is a block diagram illustrating an example of a system that includes a transmitter with a π-modulator and a receiver in accordance with an embodiment of the present disclosure.

FIG. 15 is a block diagram illustrating an example of a device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A π-modulator may receive an input data stream having a bit time. Then, a π-modulator encoder in the π-modulator may provide, based on the input data stream, at least a first encoded data stream and a second encoded data stream, which each have the bit time. Moreover, a phase delay element in the π-modulator may apply a predefined temporal delay to the second encoded data stream, so that the first encoded data stream and the second encoded data stream are temporally offset from each other. Next, a segmented optical modulator, which includes at least a first phase modulator and a second phase modulator in series with each other, may provide an output optical data stream having one half of the bit time. Notably, the first phase modulator may modulate an optical signal based on the first encoded data stream and the second phase modulator may modulate the optical signal based on the second encoded data stream.

By generating and modulating the first encoded data stream and the second encoded data stream, this optical technique may increase the data rate of the input data stream. For example, the π-modulator may double the data rate of the input data stream. Moreover, the π-modulator may increase the data rate without: using exotic materials in optical modulators in the π-modulator; and/or without requiring the use of short optical pulses. Consequently, the optical technique may enable high data-rate applications (such as in data centers) in optical communication and optical networks.

We now describe embodiments of the π-modulator that improves baud-rate (or symbol rate) of binary or multi-level data transmission without the need for short optical pulses (such as optical pulses having a duration less than 1-5 ps) is described. This π-modulator may increase the modulation speed of EOMs by using time and phase interleaving for optical signal generation. Notably, in the π-modulator, a time-multiplexing technique may be applied to EOM drivers with coherent phase addition of the modulated optical signals at the EOM output(s) in order to overcome bandwidth limitations and to multiply the bit-rate of binary or multi-level or N-ary (where N is a non-zero integer) encoded signals. While a binary input data stream with bits to the π-modulator and a binary output optical data stream with bits from the π-modulator are used as an illustrative example, in multi-level embodiments the input data stream to and the output optical data stream from the π-modulator may each include symbols. Note that π-modulation may be complementary to (and, thus, used with) other optical techniques, such as wavelength-division multiplexing (WDM), polarization multiplexing, error correction codes, etc.

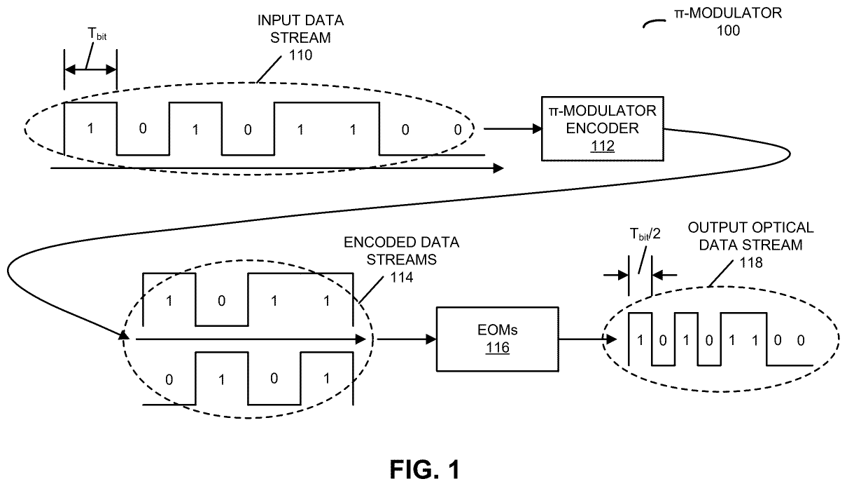

The π-modulator may be a device that increases the aggregate data rate by expediting transitions. This is illustrated in FIG. 1, which presents a drawing illustrating an example of the operation of a non-return-to-zero (NRZ) interleaved π-modulator 100. Notably, π-modulator 100 may operate by using a π-modulator encoder 112 and (at least) two EOMs 116 in parallel. π-modulator encoder 112 may convert an input data stream 110 into symbols in two encoded data streams 114. Moreover, EOMs 116 may operate with a phase-shifted clock and may interchangeably provide a symbol in order to create a desired transition in an output optical data stream 118. For example, if the current symbol is ‘1,’ EOMs 116 may provide ‘−1’ to perform a transition to ‘0’ after one half of a symbol time. Alternatively, EOMs 116 may provide ‘0’ to keep the ‘1’ if the next expected symbol in output optical data stream 118 is ‘1’. Stated differently, π-modulator 100 may provide the complementary symbol to generate a transition at one half of the symbol time.

In FIG. 1, note that input data stream 110 has a bit time of T_{bit} and a bit or data rate of f_{bit} equal to 1/T_{bit}. Moreover, EOMs 116 may operate at a maximum frequency of f_{bit}. Furthermore, encoded data streams 114 may be phase-shifted in time by T_{bit}/2. Additionally, output optical data stream 118 may include the same data as input data stream 110 at twice the data rate, i.e., 2f_{bit}. Consequently, a bit time of output optical data stream 118 may be one half of the input data rate, i.e., T_{bit}/2.

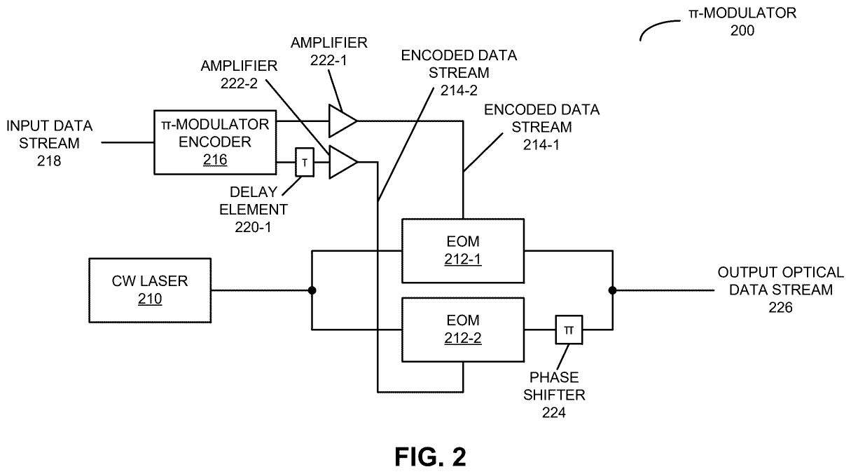

FIG. 2 presents a block diagram illustrating an example of a π-modulator 200. A continuous-wave (CW) laser 210 (and, more generally, an optical source, such as a laser diode or an LED) may provide an optical signal to two EOMs 212. Each of EOMs 212 may accept half of the encoded data streams 214 (such as electrical signals) provided by π-modulator encoder 216, which each have the original data rate of an input data stream 218 (such as an electrical signal that conveys a data stream of bits or symbols). Note that the delay element 220-1 may provide a predefined delay T (such as a one half of a bit time delay) to encoded data stream 214-2 provided by π-modulator encoder 216, and encoded data streams 214 may be amplified by amplifiers 222 before being input to EOMs 212. Moreover, an output of EOM 212-2 in the optical domain may be delayed by phase shifter 224 by one half of a cycle, so that there destructive or constructive interference with an output of EOM 212-1. Thus, phase shifter 224 may convert a high optical amplitude that may represent a digital ‘1’ to a ‘−1.’ Furthermore, output optical data stream 226 may be the sum of the complex amplitude of the coherent beams provided by EOMs 212 and may have three phase levels: ‘0,’ ‘1’ (a phase of π) and ‘−1’ (a phase of −π). Because at a receiver, a photodiode detector may be a square-law (power) detector that is proportional to the square of the light amplitude, the phase levels of ‘−1’ and ‘1’ may be detected as a digital ‘1’ and the ‘0’ as a digital ‘0.’

The encoding process performed by π-modulator encoder 216 may expedite transitions at one half of the original bit time of input data stream 218 by providing the appropriate expediting symbols. For example, in order to expedite a transition from ‘1’ to a ‘0,’ a ‘−1’ may be provided. Similarly, in order to expedite a transition from a ‘0’ to a ‘1,’ a ‘1’ may be provided, etc. π-modulator encoder 216 may choose the expediting symbol by looking at the current symbol and the next symbol, and then may provide the correct expediting symbol to EOM 212-2.

Notably, let S(t) be the original input data stream 218, and S₁(t) and S₂(t) are encoded data streams 214 feeding EOM 212-1 and EOM 212-2, respectively. In order to generate the correct transitions in output optical data stream 226, a precoding of the data in input data stream 218 may be used. Thus, the bitstream S(t) may be encoded and provided to EOMs 212 as inputs S₁(t) and S₂(t).

For example, the precoding rule implemented by π-modulator encoder 216 may be

S_{y}(tₙ₊₁)=Sₓ(tₙ) XOR S(tₙ₊₁), (1)

where {x=1, y=2} or {x=2, y=1}, tₙ is the current symbol and tn+1 is the next or subsequent symbol. The encoding of symbols in input data stream 218 using Eqn. 1 is illustrated in Table 1.

TABLE 1

| Sₓ(tₙ) | S(tₙ₊₁) | S_{y}(tₙ₊₁) |
|---|---|---|
| 0 | 0 | 0 |
| 1 | 0 | 1 |
| 0 | 1 | 1 |
| 1 | 1 | 0 |

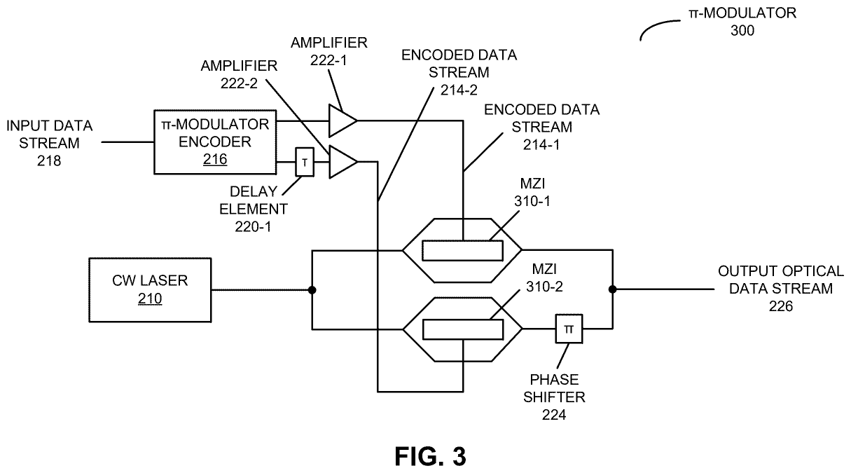

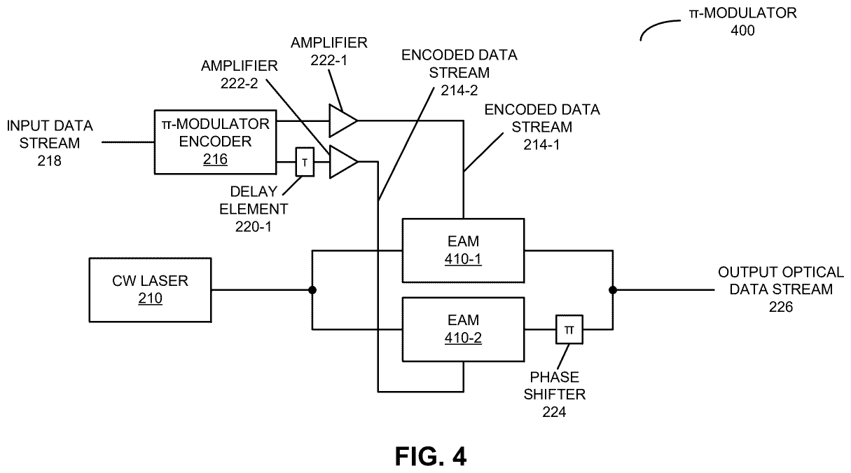

In general, the EOMs in the embodiments of the π-modulator (such as EOMs 212) can be any type of optical modulator, such as: a Mach-Zehnder modulator (MZM), a micro-ring modulator (MRM), a micro-disk modulator (MDM), and/or an electro-absorption modulator (EAM) operated as a phase-shift element. For example, EOMs can include: high-speed pn junctions, pin phase shifters, Frans-Keldysh-effect (FKE) phase-shift elements and/or quantum-confined Stark effect (QCSE) phase-shift elements. For example, FIG. 3 presents a block diagram illustrating an example of a π-modulator 300 with MZMs 310, and FIG. 4 presents a block diagram illustrating an example of a π-modulator 400 with EAMs 410. In some embodiments, the EOMs may operate at 50 G symbols/s. Note that π-modulator 200 (FIG. 2), π-modulator 300 (FIG. 3) or π-modulator 400 may be used when the ability to have multiple electrodes on the EOMs is unavailable (such as when off-the-shelf components are used) and/or when amplitude modulation is used (instead of phase modulation).

Referring back to FIG. 2, note that this optical technique can be extended to multiply the aggregate bit rate by factor of N, where N is a non-zero integer. For example, an even integer number of EOMs may be put in parallel. If these EOMs have indices 1, . . . , N, an EOM with an even index may have a π phase shifter at its output. As an input, a laser or an optical source (such as a laser diode or an LED) may provide an optical signal that is split equally among the N EOMs. Moreover, the outputs of the N EOMs may be combined.

While FIG. 2 is illustrated with amplifiers 222 between π-modulator encoder 216 and EOMs 212, in some embodiments the amplification may occur after EOMs 212. Moreover, while the embodiments of the π-modulator are illustrated as including π-modulator encoder 216, in other embodiments π-modulator encoder 216 may be external to the π-modulator (such as π-modulator 200).

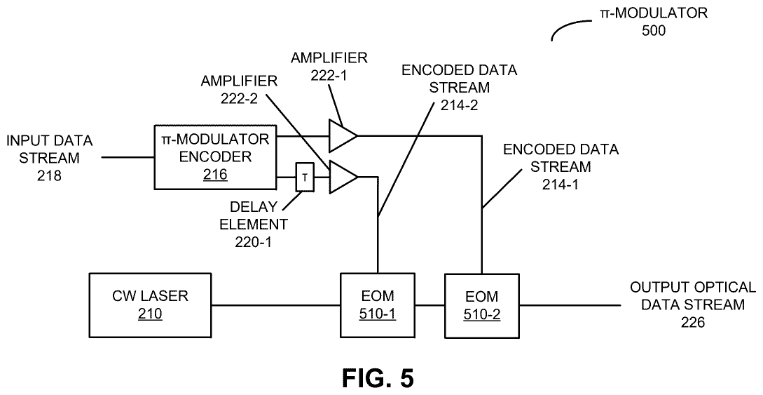

In some embodiments, the optical modulators in a π-modulator may be implemented in tandem or series instead of in parallel, e.g., in an NRZ tandem interleaved π-modulator with a decoding receiver. This is illustrated in FIG. 5, which presents a block diagram illustrating an example of a π-modulator 500 with two EOMs 510 in series. In π-modulator 500, incoming data stream 218 may be encoded by π-modulator encoder 216, which outputs encoded data streams 2008 that drive series-coupled EOMs 500. Moreover, delay element 220-1 may delay encoded data stream 214-1 by one half of the bit time of input data stream 218. Therefore, EOM 510-2 may be actuated with a time delay of one half of the bit time relative to EOM 510-1. Consequently, at each instance symbols in encoded data streams 214, only one of EOMs 510 may be modulating the optical signal to generate the correct NRZ symbol in output optical data stream 226 by expediting a transition from the current symbol.

An advantage of this configuration compared to the parallel-modulator configuration of π-modulators 200 (FIG. 2), 300 (FIG. 3) and 400 (FIG. 4), in which the optical modulators are in parallel, is that it may not have an inherent 3 dB optical loss associated with a power combiner at the output. However, the configuration of π-modulator 500 may require a dedicated decoder at the receiver. Note that the maximum data rate increase possible with this configuration may be 50% (and not 100% or ×2 as in the parallel-modulator configuration).

Note that π-modulator encoder 216 may encode input data stream 218 by adding a ‘1’ after each ‘0.’ The resulting encoded data stream may be divided into encoded data streams 214 for the two-time interleaved EOMs 510. Consequently, the encoding may generate a pair of zeros at the receiver, i.e., ‘00.’ Therefore, a decoder in the receiver may be used to remove one of the zeros.

For example, a transmitter that includes π-modulator 500, may receive input data stream 218 of ‘1001101’ (where the first bit is not part of the data), and the encoded data stream may be ‘1010111011.’ Moreover, a receiver may receive output optical data stream 226 of ‘000011001,’ and the decoded data stream output by the decoder in the receiver may be ‘001101.’

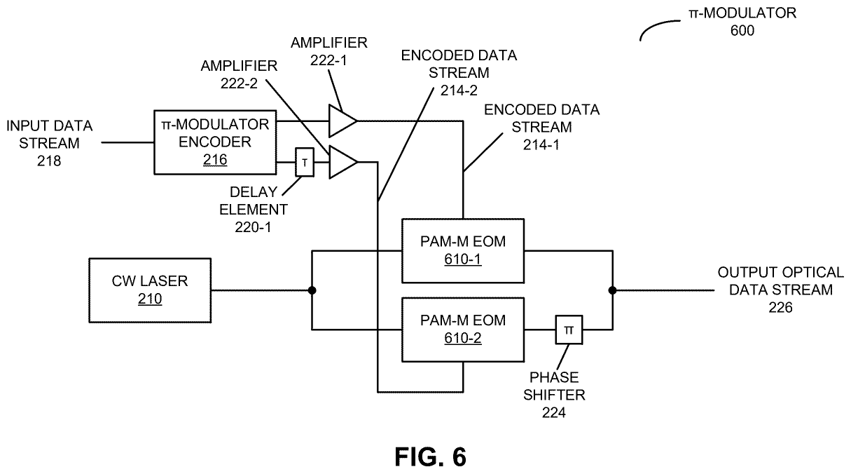

In some embodiments, the π-modulator may implement multi-level PAM-N. For example, the optical technique may be used in a PAM-N NRZ interleaved π-modulator. This is shown in FIG. 6, which presents a block diagram illustrating an example of a PAM-N π-modulator 600. In π-modulator 600, two PAM-M EOMs 610 may be supplied by two encoded data streams 214, where encoded data stream 214-2 may be delayed by one half of a bit time of input data stream 218, and M may be greater than or equal to N, and M and N may be non-zero integers. For example, for PAM-4 (4-level encoding), PAM-6 modulators may be used as EOMs 610. Note that PAM-6 modulators may be used to generate double data-rate PAM-4 is in order to provide a steep transient that is needed to transition between symbols in the output. For example, because of the π phase shift, EOM 610-2 may efficiently provide negative symbols. As illustrated in Table 2, in order to change from a symbol of ‘−3’ (which may be detected as a ‘3’ by a square-law or power detector) to a symbol of ‘2,’ a transition of 5 levels may be need. (If PAM-6 is not used in EOMs 610, current, desired and subsequent symbols such as {−1, 3, 4}, {−2, 3, 5}, {−3, 1, 4} and {−3, 2, 5} may not be possible.) Alternatively, in some embodiments, phase shift 224 may be a switchable phase shifter that can switch between phases of 0 and π as needed. Note that the PAM-6 modulators may only be required in π-modulator 600 (i.e., in a transmitter). A corresponding receiver may use a simpler PAM-4. Thus, overall, the link may be PAM-4 with twice the data rate of input data stream 218.

TABLE 2

| Current | Desired | Subsequent | Current | Desired | Subsequent |
|---|---|---|---|---|---|
| Symbol | Symbol | Symbol | Symbol | Symbol | Symbol |
| 0 | 0 | 0 | −1 | 0 | 1 |
| 0 | 1 | 1 | −1 | 1 | 0 |
| 0 | 2 | 2 | −1 | 2 | 3 |
| 0 | 3 | 3 | −1 | 2 | 4 |
| 1 | 0 | −1 | −2 | 0 | 2 |
| 1 | 1 | 0 | −2 | 1 | 3 |
| −1 | 2 | −1 | −2 | 2 | 0 |
| 1 | 3 | −2 | −2 | 3 | 5 |
| 2 | 0 | −2 | −3 | 0 | 3 |
| 2 | 1 | −1 | −3 | 1 | 4 |
| 2 | 2 | 0 | −3 | 2 | 5 |
| 2 | 3 | −1 | −3 | 3 | 0 |
| 3 | 0 | −3 | — | — | — |
| 3 | 1 | −2 | — | — | — |
| 3 | 2 | −1 | — | — | — |
| 3 | 3 | 0 | — | — | — |

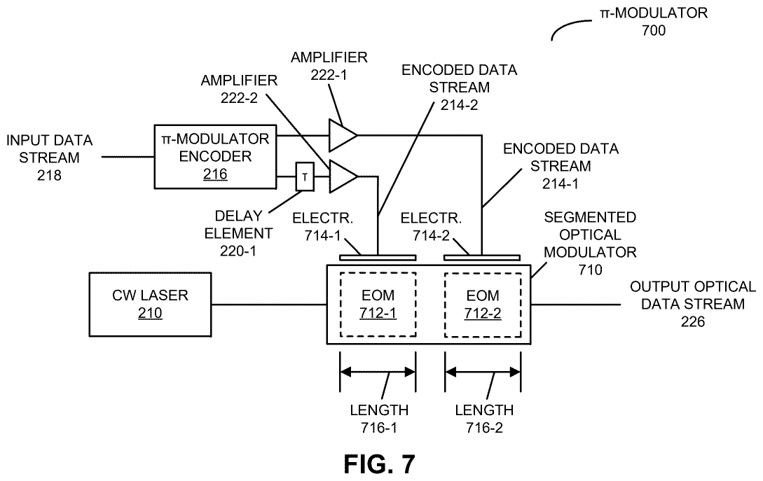

In some embodiments, the optical technique is used to implement an NRZ phase-interleaved π-modulator with a segmented modulator. Notably, in π-modulator 200 (FIG. 2), π-modulator 300 (FIG. 4) and π-modulator 400 (FIG. 4), there may be an additional 3 dB optical loss or penalty associated with using the π-modulator. However, when using phase-modulators in a segmented geometry, the 3 dB optical loss can be completely avoided by using a single power-combining element at the output. This is shown in FIG. 7, which presents a block diagram illustrating an example of a π-modulator 700 with a segmented optical modulator 710 having segmented EOMs 712 in series. These EOMs may be an MZM, an MRM, an MRD, and/or an EAM operating as phase modulators. In embodiments where EOMs 712 are included in a single segmented device (i.e., segmented optical modulator 710), electrodes 714 associated with EOMs 712 may have equal lengths 716. Moreover, encoded data streams 218 S₁(t) and S₂(t) may be capable of generating binary voltages levels equal to a 0 and a π phase shift, which may represent a digital ‘0’ and a digital ‘1’ in input data stream 218. In embodiments of the π-modulator with a segmented optical modulator the 180° phase shift associated with phase shifter 224 may be implemented in the segmented optical modulator (e.g., segmented optical modulator 700), such as based on the distance or spacing between electrodes 714 (and, thus, EOMs 712) in segmented optical modulator 700.

Note that the mechanism of π-modulator 700 may be similar to other embodiments of the π-modulator. Notably, in a π-modulator, transitions between symbols may be expedites by encoding the input data stream to include expediting symbols. In embodiments based on amplitude, the input data stream may be encoded using the amplitudes, so that the output optical data stream includes three symbols of 0, 1, −1, and a square-law or power detector may detect the 1 and −1 symbols as representing the same data. In the segmented EOMs 712, input data stream 218 may be encoded based on the optical phase, and the expediting symbols may be phase levels of 0 and π. The possible phase levels in output optical data stream 226 may be 0, π and 2π, where 0 and 2π represent the same data. Furthermore, the amplitude or intensity in output optical data stream 218 may be low (such as ‘0’) for a phase level of π or high (such as ‘1’) for a phase level of 0 or 2π. Note that amplifier 222-1 may be actuated with a time delay of one half of a bit time relative to amplifier 222-2. Consequently, for each instance of a symbol in encoded data streams 214, only one of EOMs 712 may be modulating the optical signal to generate the correct NRZ symbol in output optical data stream 226 by expediting a transition from the current symbol.

In π-modulator 700, the precoding rule implemented by π-modulator encoder 216 may be

S_{y}(tₙ₊₁)=Sₓ(tₙ) XOR S(tₙ₊₁), (2)

where {x=1, y=2} or {x=2, y=1}, tₙ is the current symbol and tn+1 is the next or subsequent symbol. The phase encoding of symbols in input data stream 218 using Eqn. 2 is illustrated in Table 3.

TABLE 3

| Sₓ(tₙ) | S(tₙ₊₁) | S_{y}(tₙ₊₁) |
|---|---|---|
| 0 | 0 | 0 |
| π | 0 | π |
| 0 | π | π |
| π | π | 0 |

While the preceding discussion illustrated the segmented EOMs 712 in a single segmented device (i.e., segmented optical modulator 710), in other embodiments two separate phase-shifting modulators coupled in series may be used (which is a phase modulating analog to π-modulator 500 in FIG. 5). In these embodiments, each phase-shifting modulator may be an MZM driven with the same signal in both arms. Moreover, each of the arms may perform phase modulation using, e.g., an MRM, an MDM and/or an EAM operating as phase shifters (i.e., without amplitude modulation).

The configuration shown in FIG. 7 may be used to implement a PAM-N NRZ phase-interleaved π-modulator with a segmented modulator. Notably, the NRZ interleaved π-modulator configuration in FIG. 7 can be extended to generate PAM-N signals by using at least 2^{N} electrodes. For example, in order to generate a PAM-4 NRZ, there may be four electrodes and each electrode may be driven by a binary signal. For higher formats (i.e., N greater than 4), a linearization technique, such as direct digital drive, may be used for proper operation of the π-modulator.

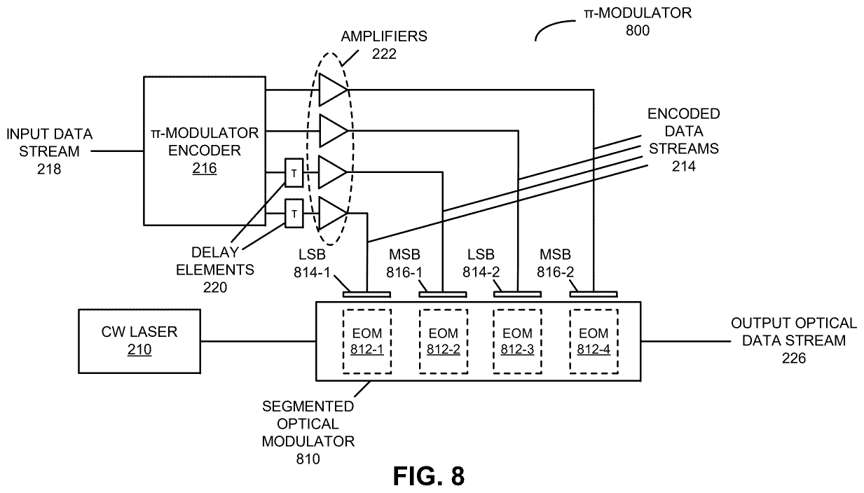

FIG. 8 presents a block diagram illustrating an example of a PAM-4 π-modulator 800 with a segmented optical modulator 810 that includes EOMs 812. Segmented optical modulator 810 may include a set of four electrodes: a least-significant byte (LSB) 814-1 and a most-significant byte (MSB) 816-1 for generating a PAM-4 symbol using EOM 812-1, and an LSB 814-2 and an MSB 816-2 for generating a second PAM-4 symbol using EOM 812-2. Note that LSB 814-2 and MSB 816-2 may be actuated with a time delay of one half of a bit time relative to LSB 814-1 and MSB 816-1. Consequently, in each instance of a symbol in encoded data streams 214, only one set, either LSB 814-1 and MSB 816-1 or LSB 814-2 and MSB 816-2, may be modulating the optical signal to generate the correct PAM-4 symbol in output optical data stream 226 by expediting a transition from the current symbol.

As an example, a PAM-4 π-modulator can be implemented using a segmented Mach-Zehnder modulator. The transfer function of the PAM-4 π-modulator may be: Iₒᵤₜ(tₙ₊₁)=2 cos((ω_{LSBx}(tₙ)+Φ_{MSBx}(tₙ)+Φ_{LSBy}(tₙ₊₁)+Φ_{MSBy}(tₙ₊₁))/2), where Φ_{LSBx}(tₙ) and Φ_{MSBx}(tₙ) are the phase shift on LSB 814-x and MSB 816-x in the current (half-symbol) time cycle and Φ_{LSBy}(tₙ₊₁) and Φ_{MSBy}(tₙ₊₁) are the phase shift on LSB 814-y and MSB 816-y in the next or subsequent time cycle, where {x=1, y=2} or {x=2, y=1}.

Note that a common figure of merit for optical modulators is that the product L_{π}V_{π} equals a constant, which means that for an optical modulator interaction length of L_{π} of 1 (in arbitrary units), an actuation voltage of V_{π} equal to a constant (in units of Volts) may be required to induce a phase shift of π. In order for PAM-4 π-modulator to work, it may need to generate optical levels of 0, ⅓, ⅔ and 1. Note that the phase shift required to generate an output power of ⅓ may be 2 cos(sqrt(⅓)) or 1.91 (in units of radians) and the phase shift required to generate an output power of ⅔ may be 2 cos(sqrt(⅔)) or 1.23 (in units of radians).

Dividing the total interaction length L_{π} into two segments (and, thus, electrodes) of lengths of approximately 0.6L_{π} and approximately 0.4L_{π} may require a total of 3 voltage levels: 0, ±V_{π}. Note that the absolute value of V_{π} (in unit of Volts) may depend on the actual interaction length in units of millimeters. Moreover, other segmentation options may be possible. For example, as discussed previously in FIG. 7, there may be two equal segments (and, thus, two electrodes of equal length), but then five or six different voltage levels may be required: either 0 and ±V_{LSB1,2}, ±V_{MSB1,2} or three different levels for each of LSBs 814 and MSBs 816, respectively. Moreover, note that increasing the number of segments (or electrodes) may allow the use of binary signaling instead of trinary signaling. Furthermore, note that a reduction of the actuation voltages may be possible by reducing the dynamic range of output optical data stream 226 to a smaller range than 0 to 1.

The phase encoding of symbols in input data stream 218 for a PAM-4 π-modulator with a segmented optical modulator is illustrated in Table 4.

TABLE 4

| Φ_{LSBx}(tₙ) | Φ_{MSBx}(tₙ) | Iₒᵤₜ(tₙ₊₁) | Φ_{LSBy}(tₙ) | Φ_{MSBy}(tₙ) |
|---|---|---|---|---|
| (rad) | (rad) | (arb. units) | (rad) | (rad) |
| 0 | 0 | 0 | 1.23 | 1.91 |
| 0 | 0 | 1/3 | 0 | 1.91 |
| 0 | 0 | 2/3 | 1.23 | 0 |
| 0 | 0 | 1 | 0 | 0 |
| 0 | 1.91 | 0 | 1.23 | 0 |
| 0 | 1.91 | 1/3 | 0 | 0 |
| 0 | 1.91 | 2/3 | 1.23 | 1.91 |
| 0 | 1.91 | 1 | 0 | −1.91 |
| 1.23 | 0 | 0 | 0 | 1.91 |
| 1.23 | 0 | 1/3 | 1.23 | 1.91 |
| 1.23 | 0 | 2/3 | 0 | 0 |
| 1.23 | 0 | 1 | −1.23 | 0 |
| 1.23 | 1.91 | 0 | 0 | 0 |
| 1.23 | 1.91 | 1/3 | 1.23 | 0 |
| 1.23 | 1.91 | 2/3 | 0 | 1.91 |
| 1.23 | 1.91 | 1 | 1.23 | 1.91 |
| 0 | −1.91 | 0 | −1.23 | 0 |
| 0 | −1.91 | 1/3 | 0 | 0 |
| 0 | −1.91 | 2/3 | 1.23 | 1.91 |
| 0 | −1.91 | 1 | 0 | 1.91 |
| −1.23 | 0 | 0 | 0 | −1.91 |
| −1.23 | 0 | 1/3 | 1.23 | 1.91 |
| −1.23 | 0 | 2/3 | 0 | 0 |
| −1.23 | 0 | 1 | 1.23 | 0 |

In some embodiments, the optical technique in the π-modulator can be extended and used with other advanced modulation formats, such as N-PSK and M-QAM. Recall that a π-modulator may expedite transitions by using at least two lower-speed optical modulators and generating aggregated data that may have at least twice the data rate.

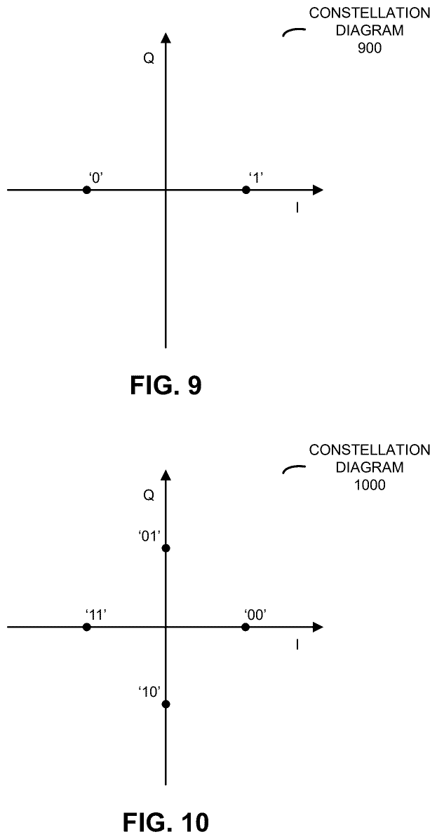

For BPSK, the configuration of π-modulator 700 (FIG. 7) may be used. FIG. 9 presents a drawing illustrating an example of a constellation diagram 900 for BPSK. BPSK may have two symbols with (normalized) amplitudes of 1. The phase difference between these symbols may be π. For example, the phase levels for BPSK may be 0 and π, which fulfills the previous condition. In FIG. 7, segmented optical modulator 710 may be a segmented electro-optical phase modulator (EOPM) with two segments or electrodes for two phase modulators that are in series. Each segment may accept a digital ‘0’ or ‘1,’ and may induce phases of 0 and π. The amplitude may be constant. In order to facilitate aggregation of encoded data streams 214 coming from amplifiers 22 at twice the data rate of segmented EOMs 712, π-modulator encoder 216 may encode input data stream 218 as shown in Table 3. In Table 3, note that adding π+π=2π=0. Moreover, the expediting symbols may be determined based on the current symbol and the next or subsequent desired symbol.

For QPSK, the configuration of π-modulator 800 (FIG. 8) may be used. FIG. 10 presents a drawing illustrating an example of a constellation diagram 1000 for QPSK. QPSK may have four different phase levels, each representing two bits or symbols. The phases in the QPSK modulation format may be 0, π/2, −π, −π/2. Moreover, the expediting symbols in the encoding may be specified according to Table 5.

TABLE 5

| Sₓ(tₙ) | S(tₙ₊₁) | S_{y}(tₙ₊₁) |
|---|---|---|
| 0 | 0 | 0 |
| 0 | π/2 | π/2 |
| 0 | π | π |
| 0 | −π/2 | −π/2 |
| π/2 | 0 | −π/2 |
| π/2 | π/2 | 0 |
| π/2 | π | π/2 |
| π/2 | −π/2 | π |
| π | 0 | π |
| π | π/2 | −π/2 |
| π | π | 0 |
| π | −π/2 | π/2 |
| −π/2 | 0 | π/2 |
| −π/2 | π/2 | π |
| −π/2 | π | −π/2 |
| −π/2 | −π/2 | 0 |

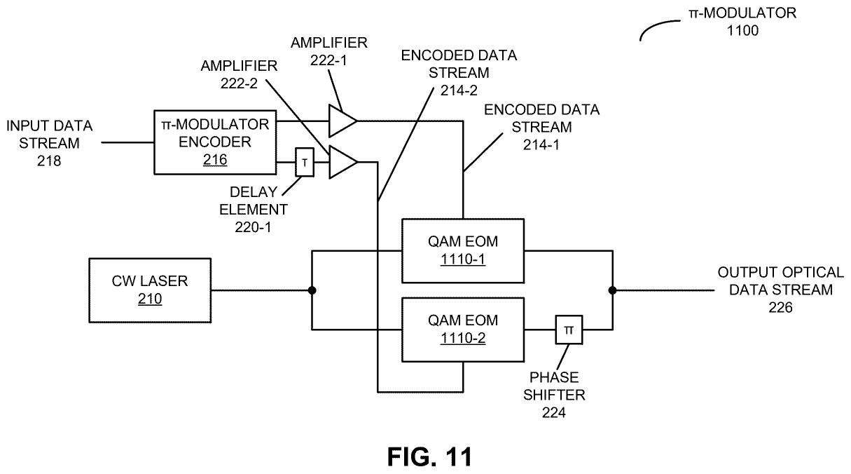

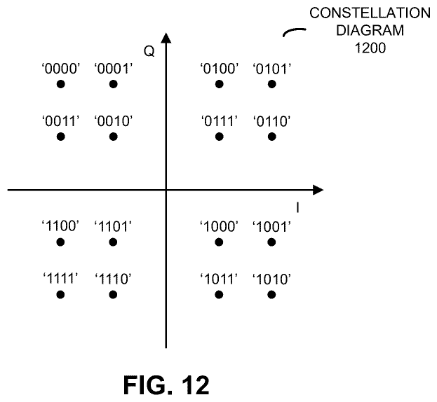

As another example, FIG. 11 presents a block diagram illustrating an example of 16 quadrature amplitude modulator (16-QAM) π-modulator 1100. π-modulator 1100 may include QAM EOMs 1110. FIG. 12 presents a drawing illustrating an example of a constellation diagram 1200 for 16-QAM. In π-modulator 1100, the expediting symbol in the encoding may be the complex difference between the current symbol and next or subsequent symbol,

Sy(tn+1)=Sx(tn)−S(tn+1),

where {x=1, y=2} or {x=2, y=1}, tn is the current symbol and tn+1 is the next or subsequent symbol.

For example, designate a value ‘0000’ as −3+3j and a value ‘1000’ as 1−j. If the current output of QAM EOM 1110-1 is −3+3j, then in order to expedite a symbol transition, the output of QAM EOM 1110-2 may be 4−4j. Note that this may be a new symbol that is not part of a standard 16-QAM coding or format. Moreover, note that in order to expedite symbol transitions for 16-QAM π-modulator 1100, 49 different control symbols may be required for all 256 possible symbol transitions.

Note that QAM EOMs 1110 may be implemented in a variety of ways. For example, each of QAM EOMs 1110 may be a QAM modulator composed dual parallel EOMs, such as an MZM, an MRM, an MDM and/or an EAM. Alternately, each of QAM EOMs 1110 may be implemented as a direct digital drive modulator.

The embodiments of the π-modulator may be robustness in the presence of electronic and photonics non-idealities. For example, Monte-Carlo simulations of real-world non-idealities were performed for a π-modulator link. The non-idealities included: modulator insertion loss, finite modulator rise-times and fall-times, and/or limited on/off extinction ratios. Notably, in the simulation, the π-modulator link was tested for degraded modulation rise and fall times between 5 and 40%, modulator insertion losses between 3 and 10 dB, and modulator extinction ratios between 10 and 3 dB. In these simulations, by appropriately biasing the EOMs and the receiver decision threshold, correct, error-free operation was obtained.

While some of the preceding embodiments of the π-modulator included modulators in only one arm of each MZM, in other embodiments the optical technique may be extended to modulators in both of the arms to reduce the length or the amount of phase shift required from each arm. Note that these modulators or phase-shift elements may include: high-speed pn junctions, pin phase shifters, FKE phase-shift elements and/or QCSE phase-shift elements.

Note that the preceding embodiments may include additional or fewer components. Moreover, positions of one or more components may be changed, two or more components may be combined into a single component and/or a component may be divided into two or more components.

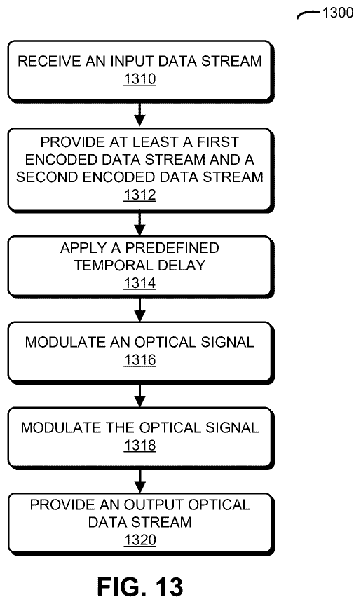

We now describe embodiments of the method. FIG. 13 presents a flow chart illustrating a method 1300 for providing an output optical data stream, which may be performed by an π-modulator (such as one of the previous embodiments of the π-modulator in the optical technique). During operation, the π-modulator may receive an input data stream (operation 1310) having a bit time. Then, the π-modulator may provide, based on the input data stream, at least a first encoded data stream and a second encoded data stream (operation 1312), where the first encoded data stream and the second encoded data stream each have the bit time. Moreover, the π-modulator may apply a predefined temporal delay (operation 1314) to the second encoded data stream, so that the first encoded data stream and the second encoded data stream are temporally offset from each other. Next, the π-modulator may modulate, using a first phase modulator in a segmented optical modulator in the π-modulator, an optical signal (operation 1316) based on the first encoded data stream. Furthermore, the π-modulator may modulate, using a second phase modulator in the segmented optical modulator in the π-modulator, the optical signal (operation 1318) based on the second encoded data stream, where the first phase modulator and the second phase modulator are in series. Additionally, the π-modulator may provide an output optical data stream (operation 1320) having one half of the bit time.

In some embodiments of method 1300, there may be additional or fewer operations. Moreover, there may be one or more different operations. Furthermore, the order of the operations may be changed, and/or two or more operations may be combined into a single operation.

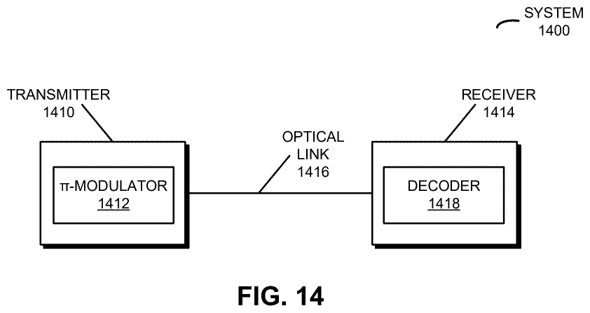

We now describe embodiments of a system, which may perform at least some of the operations in the optical technique. FIG. 14 presents a block diagram illustrating an example of a system 1400 that includes a transmitter 1410 with a π-modulator 1412 and a receiver 1414. Transmitter 1410 may generate output optical data stream 226 based on input data stream 218 using π-modulator 1412 (which may be one of the described embodiments of the π-modulator). This output optical data stream may be conveyed as an optical signal by optical link 1416. Moreover, receiver 1414 may receive the optical signals, may detect and/or decode output optical data stream 226 (e.g., using optional decoder 1418) to recover the information included in input data stream 218.

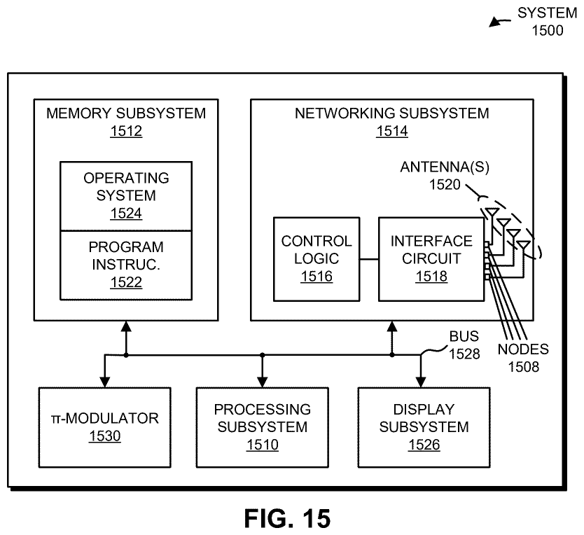

FIG. 15 presents a block diagram illustrating an example of a device 1500 (such as one or more electronic devices) in accordance with some embodiments. This device may include processing subsystem 1510, memory subsystem 1512, and networking subsystem 1514. Note that device 1500 may include at least an instance of one of the previous embodiments of the π-modulator.

Processing subsystem 1510 includes one or more devices configured to perform computational operations. For example, processing subsystem 1510 can include one or more: microprocessors, ASICs, microcontrollers, programmable-logic devices, graphics processing units (GPUs) and/or digital signal processors (DSPs).

Memory subsystem 1512 includes one or more devices for storing data and/or instructions for processing subsystem 1510 and networking subsystem 1514. For example, memory subsystem 1512 can include dynamic random access memory (DRAM), static random access memory (SRAM), and/or other types of memory. In some embodiments, instructions for processing subsystem 1510 in memory subsystem 1512 include: one or more program instructions or sets of instructions (such as program instructions 1522 or operating system 1524), which may be executed by processing subsystem 1510. Note that the one or more computer programs may constitute a computer-program mechanism. Moreover, instructions in the various modules in memory subsystem 1512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1510.

In addition, memory subsystem 1512 can include mechanisms (such as a circuit or software) for controlling access to the memory. In some embodiments, memory subsystem 1512 includes a memory hierarchy that comprises one or more caches coupled to a memory in device 1500. In some of these embodiments, one or more of the caches is located in processing subsystem 1510.

In some embodiments, memory subsystem 1512 is coupled to one or more high-capacity mass-storage devices (not shown). For example, memory subsystem 1512 can be coupled to a magnetic or optical drive, a solid-state drive, or another type of mass-storage device. In these embodiments, memory subsystem 1512 can be used by device 1500 as fast-access storage for often-used data, while the mass-storage device is used to store less frequently used data.

Networking subsystem 1514 includes one or more devices configured to couple to and communicate on a wired and/or wireless network (i.e., to perform network operations), including: control logic 1516, an interface circuit 1518 and one or more optional antennas 1520 (or antenna elements). (While FIG. 15 includes one or more antennas 1520, in some embodiments device 1500 includes one or more nodes, such as nodes 1508, e.g., a pad, which can be coupled to the one or more antennas 1520. Thus, device 1500 may or may not include the one or more antennas 1520.) For example, networking subsystem 1514 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, device 1500 may use networking subsystem 1514 for performing simple wireless communication, e.g., transmitting advertising or beacon frames and/or scanning for advertising frames transmitted by other electronic devices.

Within device 1500, processing subsystem 1510, memory subsystem 1512, networking subsystem 1514 and optional π-modulator(s) 1530 are coupled together using signal lines, links or bus 1528. These connections may include an electrical, optical, and/or electro-optical connection that the subsystems can use to communicate signals, commands and data among one another.

Furthermore, while some components are shown directly connected to one another in FIG. 15, in general coupling can also occur via intermediate components. In each instance, the method of interconnection, or ‘coupling,’ establishes some desired communication between two or more circuit nodes, or terminals. Such coupling may often be accomplished using a number of circuit configurations, as will be understood by those of skill in the art; for example, AC coupling and/or DC coupling may be used. Although only one bus 1528 (or one or more signal lines) is shown for clarity in FIG. 15, different embodiments can include a different number or configuration of electrical, optical, and/or electro-optical connections among the subsystems.

In some embodiments, device 1500 includes a display subsystem 1526 for displaying information on a display, which may include a display driver and the display, such as a liquid-crystal display, a multi-touch touchscreen, etc.

Device 1500 and/or an instance of the π-modulator may include: an integrated circuit, a VLSI circuit, a switch, a hub, a bridge, a router, a communication system (such as a wavelength-division-multiplexing communication system), a storage area network, a data center, a network (such as a local area network), and/or a computer system (such as a multiple-core processor computer system). Furthermore, the computer system and/or an instance of the π-modulator may include, but is not limited to: a desktop computer, a server (such as a multi-socket, multi-rack server), a laptop computer, a communication device or system, an access point, a router, a switch, communication equipment, a controller, test equipment, a personal computer, a work station, a mainframe computer, a blade, an enterprise computer, a data center, a tablet computer, a supercomputer, a network-attached-storage (NAS) system, a storage-area-network (SAN) system, a media player (such as an MP3 player), an appliance, a subnotebook/netbook, a tablet computer, a smartphone, a cellular telephone, a smartwatch, a network appliance, a set-top box, a personal digital assistant (PDA), a toy, a controller, a digital signal processor, a game console, a device controller, a computational engine within an appliance, a consumer-electronic device, a portable computing device or a portable electronic device, a personal organizer, a sensor (such as a LIDAR sensor), an automobile or a truck, another electronic device, a laser (such as a hybrid laser and/or another optical component.

Although specific components are used to describe device 1500, in alternative embodiments, different components and/or subsystems may be present in device 1500. For example, device 1500 may include one or more additional processing subsystems, memory subsystems, networking subsystems, display subsystems and/or one or more additional subsystems not shown in FIG. 15 (such as a user-input subsystem). Additionally, one or more of the subsystems may not be present in device 1500. Also, although separate subsystems are shown in FIG. 15, in some embodiments some or all of a given subsystem or component can be moved or integrated into one or more of the other subsystems or component(s) in device 1500. For example, in some embodiments program instructions 1522 are included in operating system 1524 and/or control logic 1516 is included in interface circuit 1518. Thus, while device 1500, as well as the previous embodiments of the π-modulator, are illustrated as having a number of discrete items, these components are intended to be functional descriptions of the various features that may be present rather than structural schematics of the embodiments described herein.

Moreover, the circuits and components in device 1500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of device 1500. In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures, such as by one or more: ASICs, FPGAs, DPSs, GPUs, etc. Therefore, some or all of the operations in the preceding embodiments may be performed in hardware, in software or both. For example, at least some of the operations in the optical technique may be implemented using program instructions 1522, operating system 1524 (such as a driver for interface circuit 1518) or in firmware in interface circuit 1518. Alternatively or additionally, at least some of the operations in the optical technique may be implemented in a physical layer, such as hardware in interface circuit 1518. In general, device 1500 may be at one location or may be distributed over multiple, geographically dispersed locations.

Moreover, the preceding embodiments of the π-modulator and/or device 1500 can be used in a wide variety of applications, such as: communications (for example, in a transceiver, an optical source (such as a laser), an optical interconnect or an optical link, such as for intra-chip or inter-chip communication), a radio-frequency filter, a bio-sensor, data storage (such as an optical-storage device or system), medicine (such as a diagnostic technique or surgery), a barcode scanner, metrology (such as precision measurements of distance), manufacturing (cutting or welding), a lithographic process, data storage (such as an optical-storage device or system), a data center and/or entertainment (a laser light show).

Moreover, while the preceding discussion included some numerical values, these values are for purposes of illustration and are not intended to be limiting. In other embodiments, different numerical values may be used.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A π-modulator, comprising:
an input node configured to receive an input data stream having a bit time;
a π-modulator encoder, coupled to the input node, configured to provide, based on the input data stream, at least a first encoded data stream and a second encoded data stream, wherein the first encoded data stream and the second encoded data stream each have the bit time;
a phase delay element, coupled to the π-modulator encoder, configured to apply a predefined temporal delay to the second encoded data stream, so that the first encoded data stream and the second encoded data stream are temporally offset from each other; and
a segmented optical modulator coupled to the π-modulator encoder and the phase delay element, wherein the segmented optical modulator comprises at least a first phase modulator and a second phase modulator,
wherein the first phase modulator is configured to modulate an optical signal based on the first encoded data stream and the second phase modulator is configured to modulate the optical signal based on the second encoded data stream,
wherein the first phase modulator and the second phase modulator are in series, and
wherein the segmented optical modulator is configured to provide an output optical data stream having one half of the bit time.

2. The π-modulator of claim 1, wherein the π-modulator encoder is configured to encode at least the first encoded data stream and the second encoded data stream to comprise expediting symbols that expedite signal transitions in the output optical data stream at a data rate corresponding to one half of the bit time.

3. The π-modulator of claim 1, wherein the π-modulator encoder is configured to phase encode at least the first encoded data stream and the second encoded data stream.

4. The π-modulator of claim 1, wherein a subsequent symbol in the second encoded data stream is an exclusive or of a current symbol in the first encoded data stream with a subsequent symbol in the input data stream, or a subsequent symbol in the first encoded data stream is an exclusive or of the current symbol in the second encoded data stream with a subsequent symbol in the input data stream.

5. The π-modulator of claim 1, wherein the temporal delay is one half of the bit time.

6. The π-modulator of claim 1, wherein the π-modulator comprises at least a first amplifier and a second amplifier between the π-modulator encoder and the segmented optical modulator; and
wherein the first amplifier is configured to amplify the first encoded data stream and the second amplifier is configured to amplify the second encoded data stream.

7. The π-modulator of claim 1, wherein a given phase modulator comprises a Mach Zehnder interferometer that is configured to be driven with a same signal in both arms, and each of the arms comprises an electro-optical modulator.

8. The π-modulator of claim 7, wherein the electro-optical modulator comprises one of: a micro-ring modulator, a micro-disk modulator, an electro-absorption modulator or a direct digital-drive modulator.

9. The π-modulator of claim 1, wherein the π-modulator comprises an optical source configured to provide the optical signal.

10. The π-modulator of claim 1, wherein the segmented optical modulator comprises a first electrode corresponding to the first phase modulator in a first region of the segmented optical modulator and a second electrode corresponding to the second phase modulator in a second region of the segmented optical modulator.

11. The π-modulator of claim 10, the segmented optical modulator comprises one of: a Mach Zehnder interferometer, a micro-ring modulator, a micro-disk modulator, an electro-absorption modulator, a direct digital-drive modulator, or another electro-optical modulator.

12. The π-modulator of claim 10, wherein the first electrode and the second electrode have different lengths, and the first encoded data stream and the second encoded data stream comprise three amplitude levels.

13. The π-modulator of claim 10, the first electrode and the second electrode have a same length, and the first encoded data stream and the second encoded data stream comprise five or six amplitude levels.

14. The π-modulator of claim 10, wherein the π-modulator is configured to implement pulse-amplitude modulation 4 (PAM-4);
wherein the first electrode comprises two electrodes for a least-significant byte (LSB) in the first encoded data stream and a most-significant byte (MSB) in the first encoded data stream;
wherein the second electrode comprises two electrodes for an LSB in the second encoded data stream and an MSB in the second encoded data stream.

15. The π-modulator of claim 1, wherein, at a given time during operation, a given one of the first phase modulator and the second phase modulator is configured to modulate the optical signal.

16. The π-modulator of claim 1, wherein the π-modulator implements one of: N phase-shift keying (N-PSK), pulse-amplitude modulation N (PAM-N), quadrature phase-shift keying (QPSK), or N quadrature amplitude modulation (N-QAM); and
wherein N is a non-zero integer.

17. A method for providing an output optical data stream, comprising:
by a π-modulator:
receiving an input data stream having a bit time;
providing, based on the input data stream, at least a first encoded data stream and a second encoded data stream, wherein the first encoded data stream and the second encoded data stream each have the bit time;
applying a predefined temporal delay to the second encoded data stream, so that the first encoded data stream and the second encoded data stream are temporally offset from each other;
modulating, using a first phase modulator in a segmented optical modulator in the π-modulator, an optical signal based on the first encoded data stream;
modulating, using a second phase modulator in the segmented optical modulator in the π-modulator, the optical signal based on the second encoded data stream, wherein the first phase modulator and the second phase modulator are in series; and
providing an output optical data stream having one half of the bit time.

18. The method of claim 17, wherein the π-modulator implements one of: N phase-shift keying (N-PSK), pulse-amplitude modulation N (PAM-N), quadrature phase-shift keying (QPSK), or N quadrature amplitude modulation (N-QAM); and
wherein N is a non-zero integer.

19. A device, comprising a π-modulator, wherein the π-modulator comprises:
an input node configured to receive an input data stream having a bit time;
a π-modulator encoder, coupled to the input node, configured to provide, based on the input data stream, at least a first encoded data stream and a second encoded data stream, wherein the first encoded data stream and the second encoded data stream each have the bit time;
a phase delay element, coupled to the π-modulator encoder, configured to apply a predefined temporal delay to the second encoded data stream, so that the first encoded data stream and the second encoded data stream are temporally offset from each other; and
a segmented optical modulator coupled to the π-modulator encoder and the phase delay element, wherein the segmented optical modulator comprises at least a first phase modulator and a second phase modulator,
wherein the first phase modulator is configured to modulate an optical signal based on the first encoded data stream and the second phase modulator is configured to modulate the optical signal based on the second encoded data stream,
wherein the first phase modulator and the second phase modulator are in series, and
wherein the segmented optical modulator is configured to provide an output optical data stream having one half of the bit time.

20. The device of claim 19, wherein the π-modulator implements one of: N phase-shift keying (N-PSK), pulse-amplitude modulation N (PAM-N), quadrature phase-shift keying (QPSK), or N quadrature amplitude modulation (N-QAM); and
wherein N is a non-zero integer.
